(19) United States
(12) Patent Application Publication
(10) Pub. No.: US 2026/0281793 A1
(43) Pub. Date: Sep. 17, 2026

(54) SYSTEMS AND METHODS FOR DETERMINING NETWORK CAPABILITY VIA CONTROL PLANE

(71) Applicant: ZTE CORPORATION, Shenzhen (CN)

(72) Inventors: Jinguo ZHU, Shenzhen (CN); Zhijun LI, Shenzhen (CN); Qiang ZHANG, Shenzhen (CN)

(21) Appl. No.: 19/168,057

(22) PCT Filed: Mar. 30, 2023
(86) PCT No.: PCT/CN2023/085167

§ 371 Date: Sep. 23, 2025

(51) Int. Cl. H04W 28/02; H04L 47/2416

(52) U.S. Cl. CPC H04W 28/0268; H04L 47/2416

(57) ABSTRACT

The present arrangement relates to systems, methods, and non-transitory computer-readable media for receiving a Policy and Charging Control (PCC) rule, Protocol Data Unit (PDU) set related information, PDU set related information in one or more Quality of Service (QOS) profiles, or any combination thereof. A wireless communication node, a first network entity of a core network, a second network entity of the core network, a third network entity of the core network, or any combination thereof, may be in wireless communication.

### CROSS-REFERENCE TO RELATED APPLICATION

This application is a national stage filing under 35 U.S.C. § 371 of international application number PCT/CN 2023/085167, filed Mar. 30, 2023, the contents of which are incorporated herein by reference in its entirety.

### TECHNICAL FIELD

The disclosure relates generally to wireless communications and, more particularly, to Protocol Data Units (PDUs).

### BACKGROUND

In 5th Generation Mobile Network System (5GC), PDU is a key technology in new radio (NR) systems supporting extended Reality (XR) services. A PDU set may include one or more PDUs carrying a payload of one unit of information generated at an application level (e.g., frames, video slices, etc.).

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

In some arrangements, a Policy and Charging Control (PCC) rule is received. A first network entity of a core network may receive the PCC rule from a second network entity of the core network, where the PCC rule may indicate service data flow information which is identified by one or more traffic filters.

In some arrangements, PDU set related information may be received. A third network entity of a core network may receive the PDU set related information from a first network entity of the core network.

In some arrangements, PDU set related information may be received. A wireless communication node may receive the PDU set related information in one or more Quality of Service (QOS) profiles from a third network entity of a core network.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication system, according to some arrangements.

FIG. 2 illustrates block diagrams of an example base station and an example user equipment device, according to some arrangements.

FIG. 3 is a diagram illustrating an example wireless communication architecture, according to various arrangements.

FIG. 4 is a diagram illustrating an example wireless communication for determining network capability via control plane, according to various arrangements.

FIG. 5 is a diagram illustrating an example wireless communication for determining network capability via control plane, according to various arrangements.

FIG. 6 is a diagram illustrating an example wireless communication for determining network capability via control plane, according to various arrangements.

FIG. 7 is a flowchart diagram illustrating an example method for determining network capability via control plane, according to various arrangements.

FIG. 8 is a flowchart diagram illustrating an example method for determining network capability via control plane, according to various arrangements.

FIG. 9 is a flowchart diagram illustrating an example method for determining network capability via control plane, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

In a wireless communications system, a wireless device may communicate with a network. In some cases, the communications may include XR traffic. For example, the communications may include traffic for mobile media services, cloud gaming, video-based tele-control for machines or drones, or cloud augmented reality (AR)/virtual reality (VR). The wireless communications system may support various procedures to support various enhancements for the communications. One such procedure may include a PDU set based QoS handling procedure. In some cases, a PDU set may be one or more PDUs carrying the payload of one unit of information generated at an application level (e.g., frames, video slices, etc., for XR services). Some network entities may support PDU set handling for XR traffic. However, some network entities may not support PDU set handling. The techniques disclosed herein provide methods for determining network capability (e.g., whether the network can support PDU set handling). To do so, wireless communications systems may communicate a Policy and Charging Control (PCC) rule, Protocol Data Unit (PDU) set related information, a Radio Access Network (RAN) capability request, PDU set related information in one or more Quality of Service (QOS) profiles, or any combination thereof.

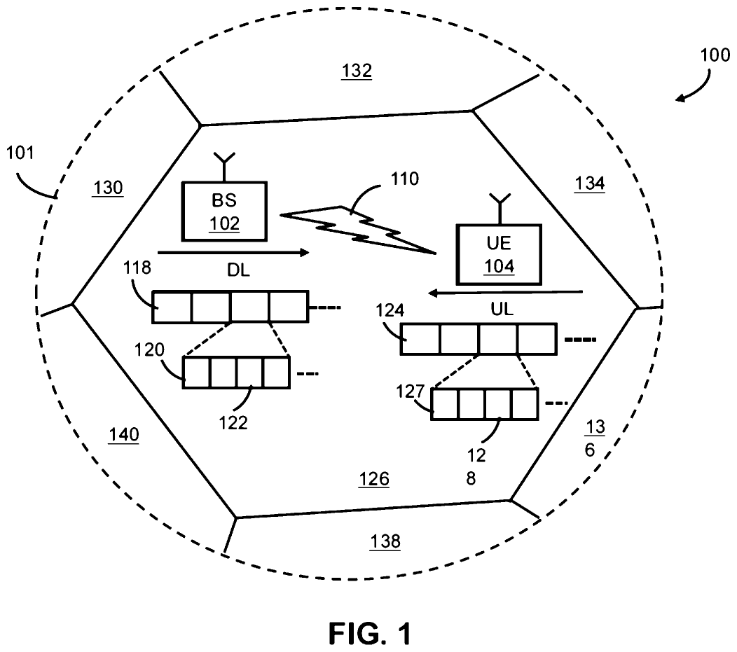

FIG. 1 illustrates an example wireless communication system 100 in which techniques disclosed herein may be implemented, in accordance with an implementation of the present disclosure. In the following discussion, the wireless communication system 100 can implement any wireless network, such as a cellular network or a narrowband Internet of things (NB-IoT) network, and is herein referred to as system 100. Such an example system 100 includes a BS 102 and a UE 104 that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one BS operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various implementations of the present solution.

In some implementations, the wireless communication system 100 may support MIMO communication. For example, MIMO is a key technology in new radio (NR) systems. MIMO may be functional in both frequency division duplex (FDD) and time division duplex (TDD) systems, among others. MIMO technologies may utilize reporting mechanisms such as CSI to support communication. CSI reports may include various types, parts, groups, and fields. The techniques described herein may provide enhancements to various aspects of the CSI report and reporting process. For example, a wireless communication device may receive, by a wireless communication device from a network, multiple reference signals and a configuration parameter. The wireless communication device may determine a CSI report based on the multiple reference signals and the configuration parameter, where the CSI report comprises CSI part 1 and CSI part 2. The wireless communication device may report, to the network, the CSI report. In some cases, the reporting process may include one or more of the following: the configuration parameter may be configured for enabling two or more CQIs in the CSI report, the reference signals are aperiodic or semi-persistent, and each of a CSI window length, DD basic unit size, an offset between two CSI reference signal (CSI-RS) resources, and a length of DD basic vector is larger than or equal to a threshold. Additionally, or alternatively, the wireless communication device may send, to the network, a User Equipment (UE) capability report indicating that the wireless communication device supports a number of CQI reports, where the number is a positive integer. The wireless communications system may implement codebooks to further support CSI reporting, among other various uses.

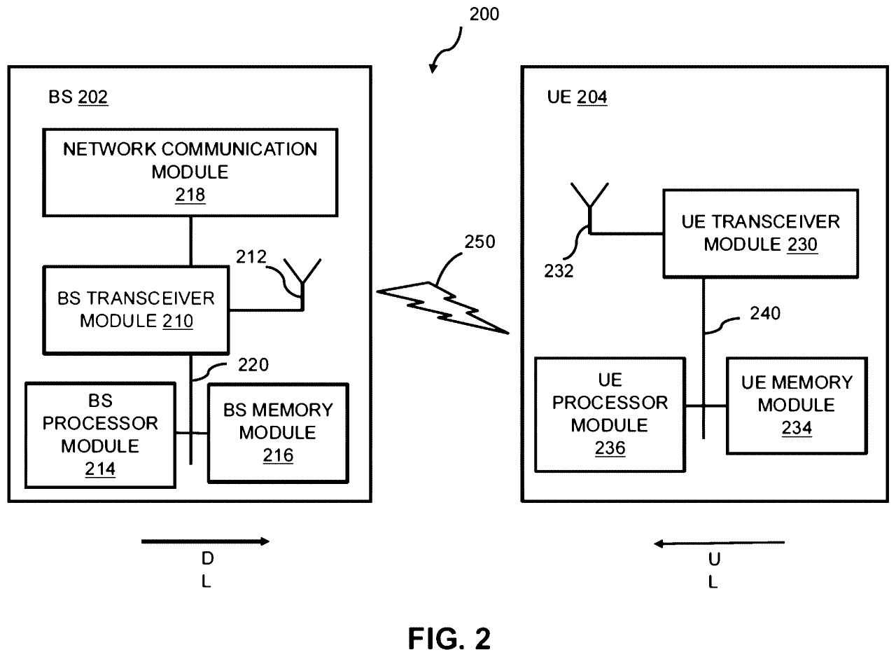

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a BS 202 and a UE 204. The BS 202 includes a Base Station (BS) transceiver module 210, a BS antenna 212, a BS processor module 214, a BS memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

The system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an uplink transceiver 230 that includes a Radio Frequency (RF) transmitter and a RF receiver each including circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each including circuity that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the BS transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the BS transceiver 210 are configured to support industry standards such as the Long Term Evolution (LTE) and emerging 5G and 6G standards, and the like. It is understood, however, that the present disclosure is not necessarily limited in application to a particular standard and associated protocols. Rather, the UE transceiver 230 and the BS transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 can be various types of user devices such as a mobile phone, a smart phone, a Personal Digital Assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the methods described in connection with the implementations disclosed herein may be implemented directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the BS 202 that enable bi-directional communication between BS transceiver 210 and other network components and communication nodes configured to communication with the BS 202. For example, network communication module 218 may be configured to support internet or WiMAX traffic. In a typical deployment, without limitation, network communication module 218 provides an 802.3 Ethernet interface such that BS transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

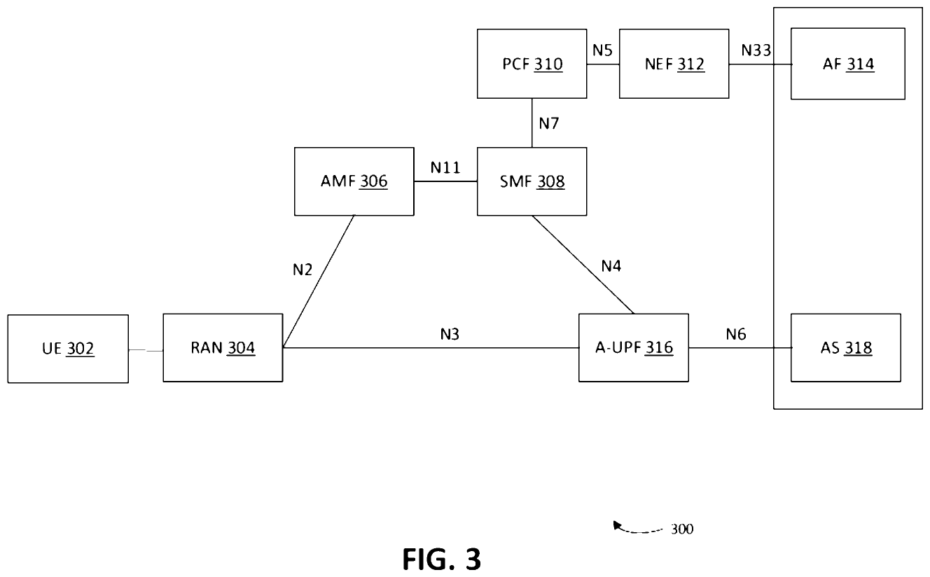

FIG. 3 is a diagram illustrating an example wireless communication architecture 300, according to various arrangements. The architecture 300 may include various entities (e.g., wireless communication nodes, network nodes, nodes). For example, the entities may include a user equipment (UE) 302, a Radio Access Network (RAN) 304, an Access and Mobility Management Function (AMF) 306, a Session Management Function (SMF) 308, a Policy Control Function (PCF) 310, a Network Exposure Function (NEF) 312, an Application Function (AF) 314, a User Plane Function (UPF) 316, and an Access Stratum (AS) 318. Each entity may be in wireless communication with another entity (e.g., as illustrated in FIG. 3 via interfaces N2, N3, N4, N5, N7, N11, and N33, among other potential interfaces).

In some examples, the RAN 304 may manage radio resources and deliver user data received over N3 (e.g., from the UPF 316) to the UE 302. The RAN 304 may deliver the user data from the UE 304 over the N3 interface (e.g., to the UPF 316). The RAN 304 may perform mapping between Dedicated Radio Bearers (DRBs) and QoS flows in a PDU session.

In some cases, the AMF 306 may include various functionalities. For example, registration management, connection management, reachability management, and mobility management. The AMF 306 may perform access authentication and access authorization. The AMF 306 may be a non-access stratum (NAS) security termination and relay session management (SM) NAS between the UE 302 and the SMF 308.

The SMF 308 may include various functionalities. For example, session establishment, modification and release, UE IP address allocation & management (e.g., including optional authorization functions), selection and control of UPF, downlink data notification, etc. The SMF 308 may control the UPF 316 via N4 association. The SMF 308 may provide Packet Detection Rule (PDR) to the UPF 316 to instruct how to detect user data traffic, Forwarding Action Rule (FAR), QOS Enforcement Rule (QER), Usage Reporting Rule (URR) (e.g., to instruct the UPF 316 how to perform user data traffic forwarding), and QoS handling and usage reporting for the user data traffic detected by using the PDR.

The PCF 310 may provide QoS policy rules to control plane functions. For example, the PCF 310 may provide the QoS policy rules to enforce the rules. The PCF 310 may transform requests from the AF 314 into PCC rules that apply to PDU Sessions.

The NEF 312 may provide a security mechanism to a third party AF to access the network (e.g., a 3GPP network). The NEF 312 may authenticate and authorize the AF 314.

The AF 314 may interact with the 3GPP Core Network to provide services. Based on operator deployment, AFs considered to be trusted by an operator can be allowed to interact directly with relevant Network Functions. AFs not allowed by the operator to access the Network Functions directly can use an external exposure framework via the NEF 312 to interact with relevant Network Functions.

The UPF 316 may include various functionalities. For example, serving as an anchor point for intra-/inter-radio access technology (RAT) mobility, packet routing & forwarding, traffic usage reporting, QoS handling for the user plane, downlink packet buffering and downlink data notification triggering, etc. In some cases, a General Packet Radio Service (GPRS) Tunneling Protocol-User plane (GTP-U) tunnel may be used over the N3 interface (e.g., between the RAN 304 and the UPF 316). The GTP-U tunnel may be per PDU session. For downlink traffic, the UPF 316 may bind the downlink traffic to QoS flows within the GTP-U tunnel of the PDU session by using FARs received from the SMF 308. For uplink traffic, the RAN 314 may transfer the user plane traffic to QoS flows identified by the UE 302.

In 5G data traffic may be encapsulated and transmitted in a QoS flow. The QoS flow may be a fine granularity for QoS forwarding treatment in a 5G system. Traffic mapped to the same 5G QoS flow may receive same forwarding treatment (e.g., scheduling policy, queue management policy, rate shaping policy, Radio Link Control (RLC) configuration, etc.).

Providing different QoS forwarding treatment may require separate 5G QOS flows.

A QOS flow may have a guaranteed bit rate (GBR) or a Non-GBR depending on a QoS profile of the QoS flow. The QoS profile of the QoS flow may contain QoS parameters and may be sent to the RAN 304. The QoS parameters may include a 5G QoS Identifier (5QI) and Allocation and Retention Priority (ARP), and other parameters (e.g., Guaranteed Flow Bit Rate (GFBR), Maximum Flow Bit Rate (MFBR), etc.). The 5QI may be a scalar used as a reference to a QoS forwarding behavior (e.g. packet loss rate, packet delay budget). The 5QI can identify a set of QoS characteristics (e.g., resource type (Non-GBR, GBR, Delay-critical GBR), priority level, packet delay budget, packet error rate, averaging window, etc.). The 5QI can be a pre-configured 5QI or a standardized 5QI.

Each QoS profile may have a corresponding QoS Flow identifier (QFI). User plane traffic with the same QFI within a PDU session may receive the same traffic forwarding treatment (e.g. scheduling, admission threshold). The QFI may be carried in an encapsulation header on N3 (and N9) without any changes to an end-to-end (E2E) packet header. The QFI may be unique within a PDU Session. The QFI may be dynamically assigned or may be equal to the 5QI.

In downlink (DL), incoming data packets may be classified by the UPF 316 based on packet filter sets of the DL PDRs in the order of their precedence. The UPF 316 may convey the classification of the user plane traffic belonging to a QoS Flow through an N3 (and N9) user plane marking (e.g., using a QFI). The AN may bind QoS flows to AN resources (e.g., DRBs for 3GPP RAN). In some cases, there may not be a one-to-one relation between QoS flows and AN resources. The AN may establish the AN resources that the QoS flows can be mapped to and release them.

In uplink (UL), the UE 302 may evaluate UL packets against an UL Packet Filters in a packet filter set in QoS rules based on a precedence value of QoS rules in increasing order until a matching QOS rule (e.g., a QoS rule with a packet filter that matches the UL packet) is found. The UE 302 may use the QFI in the corresponding matching QoS rule to bind the UL packet to a QoS flow. The UE 302 may bind QoS flows to AN resources.

For XR/media service, some PDU set QoS parameters may be defined. For example, PDU Set Delay Budget (PSDB) may define an upper bound for the delay that a PDU Set may experience for the transfer between the UE 302 and the N6 termination point at the UPF 316. PDU Set Error Rate (PSER) may define an upper bound for the rate of PDU sets that have been processed by a sender of a link layer protocol (e.g., RLC in RAN of a 3GPP access) but that are not successfully delivered by the corresponding receiver to the upper layer (e.g., packet data convergence protocol (PDCP) in RAN of a 3GPP access). PDU Set Integrated Handling Information (PSIHI) may indicate whether PDUs of the PDU set (e.g., all PDUs of the set) are needed for the usage of the PDU set by the application layer in the receiver side.

For a QoS flow supporting PDU set based QoS handling, a QoS profile of the QOS flow may include PDU set QoS parameters. The PCF 310 may determine the PDU set QoS parameters based on information provided by the AF 314 and/or local configuration. The PDU set QoS parameters may be sent to the SMF 308 as part of a PCC rule. The SMF 308 may send the parameters to the RAN 304 as part of the QoS profile. If the RAN 304 receives the PDU set QoS parameters and supports them, the RAN 304 may apply PDU set QoS parameters.

The SMF 308 may instruct a PDU Session Anchor (PSA) UPF (e.g., the UPF 316) to perform PDU set marking and may provide the PSA UPF with a protocol description indicating the header, extension header (e.g., real-time transport protocol (RTP) and/or secure RTP (SRTP)), and/or payload type (e.g., H.264) used by the service data flow. Based on SMF instructions, the UPF 316 may identify the PDU sets, according to the protocol description in the PDR, to derive PDU set information for DL traffics and send the information to the RAN 304 via respective DL GTP-U headers of each PDU identified as belonging to a PDU set. The PDU set information may be used by the RAN 304 for PDU set based QoS handling.

In some cases, the PDU set information may include a PDU set sequence number, an indication of end PDU of the PDU set, a PDU sequence number within a PDU set, a PDU set size in bytes, and a PDU set importance (e.g., identifying relative importance of a PDU set compared to other PDU sets within a QoS flow or across different QoS flows with same priority). In some implementations, the RAN 304 (e.g., an NG-RAN) may use the PDU set importance for PDU set level packet discarding in presence of congestion.

Because some XR traffic detection in the UPF 316 may use a large amount of resources and not all RAN nodes in a network may support PDU set handling, activating PDU set handling in UPF may result in various deficiencies (e.g., may not be supported, may consume large amounts of resources, etc.). The techniques disclosed herein provides methods to resolve how the network can determine RAN capability via control plane signaling. In some cases, the techniques can also be extended to other scenarios that include the core network determining other RAN capabilities.

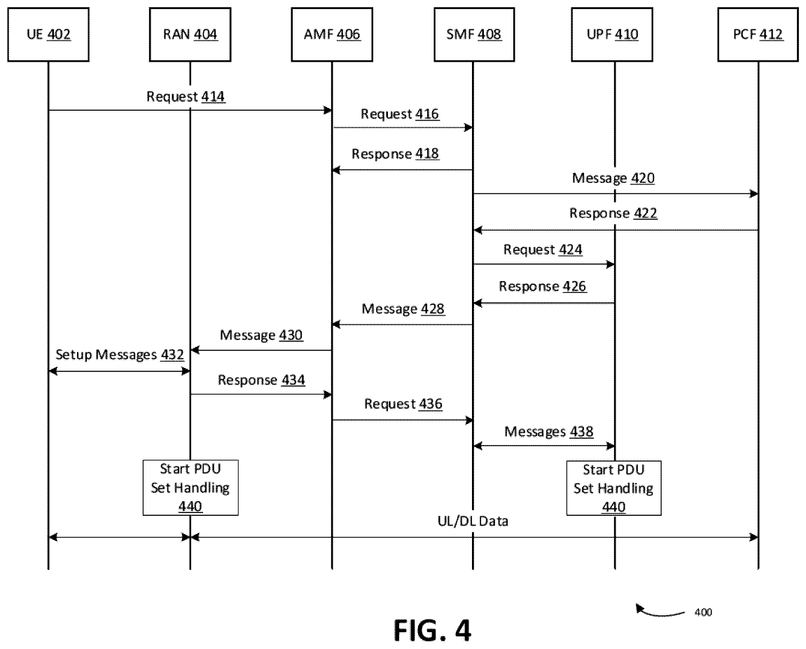

FIG. 4 is a diagram illustrating an example wireless communication 400 for determining network capability via control plane, according to various arrangements. The wireless communication 400 may include communications between a UE 402, a RAN 404, an AMF 406, an SMF 408, a UPF 410, and a PCF 412. The wireless communication 400 may depict examples of activating XR optimization during a PDU session establishment procedure. The SMF 408 may activate the PDU set handling in the UPF 410 via the control plane (e.g., signaling in the control plane). For example, a first network entity (e.g., the SMF 408) of a core network may receive, from a second network entity (e.g., the PCF 412) of the core network, a PCC rule, the PCC rule indicating service data flow information which is identified by one or more traffic filters.

The UE 402 may transmit a request 414 to the AMF 406. The request 414 may include a NAS message. The NAS message may include a data network name (DNN), a PDU session ID, and/or an N1 SM container (e.g., PDU session establishment request). To establish a new PDU Session, the UE 402 may generate a new PDU session ID. The UE 402 may initiate the UE requested PDU session establishment procedure by transmitting a NAS message containing a PDU session establishment request within the N1 SM container. The NAS message may include a UE capability indication that the UE 402 supports XR optimization. The NAS message sent by the UE may be encapsulated by the AN in an N2 message towards the AMF 406.

The AMF 406 may select an SMF (e.g., the SMF 408 supporting the XR optimization) based on the requested DNN, the UE capability indication, and other information. The AMF 406 may send a request 416 (e.g., a Nsmf_PDUSession_CreateSMContext request, SUPI, DNN, PDU Session ID, AMF ID, N1 SM container (PDU Session Establishment Request)) to the SMF 408. In some cases, a Subscription Permanent Identifier (SUPI) may uniquely identify the UE subscription. The AMF ID may be a Globally Unique AMF ID (GUAMI) of the UE 402, which may uniquely identify the AMF 406 serving the UE 402. The AMF 406 may forward the PDU session ID together with the N1 SM container including the PDU session establishment request received from the UE 402. The AMF 406 may also forward the UE capability indication to the SMF 408.

If the SMF 408 is able to process the PDU session establishment request, the SMF 408 may create an SM context and respond to the AMF 406 by providing an SM context identifier in a response 418 (e.g., an Nsmf_PDUSession_CreateSMContext response message).

The SMF 408 may send message 420 to the PCF 412 based on determining that PCC authorization is needed. The SMF 408 may request to establish an SM policy association with the PCF 412 by invoking an operation (e.g., Npcf_SMPolicyControl_Create operation included in the message 420).

The PCF 412 may perform authorization based on UE subscription and local configuration. The PCF 412 may respond to the message 420 with the response 422 (e.g., a Npcf_SMPolicyControl_Create response). The response 422 may include policy information.

The PCF 412 may determine that the PDU session can be used for XR traffic based on local configuration or information from the Application Function. In some cases, the PCF 412 may include XR information to activate XR optimization in the UE 402, the RAN 404, and the UPF 410. The XR information may include an indication to activate the XR optimization and traffic filters of the XR traffic. The traffic filters may indicate how to detect the XR traffic. For example, the filters may indicate IP 5 tuple information of XR traffic, RTP header information, RTP pay-load information, RTP Control Protocol (RTCP) header information, secure RTP (SRTP) header information, SRTP pay-load information, and/or SRTCP information, etc.

The SMF 408 may use DNN, the UE capability indication received from AMF 406, and the XR information from PCF 412, to select a UPF (e.g., the UPF 410 supporting the XR optimization). In some cases, the SMF 408 (e.g., a first network entity) may send, to the UPF 410 (e.g., a third network entity), PDU set related parameters to detect DL traffic. For example, the SMF 408 may send a request 424 (e.g., an N4 session establishment request) to the UPF 410 and provide N4 rules including packet detection rules and enforcement and reporting rules to be installed on the UPF 410 for the PDU session. The N4 rules may include protocol description in PDR to detect DL XR traffic and derive the PDU set information.

The UPF 410 may acknowledge the request 424 by sending a response 426 (e.g., an N4 session establishment response) to the SMF 408. If core network (CN) tunnel info is allocated by the UPF 410, the CN tunnel info can be provided to the SMF 408 via the response 426.

The SMF 408 may send a message 428 to the AMF 406. The message 428 may include a Namf_Communication_NIN2Message Transfer, a PDU Session ID, N2 SM information, a PDU Session ID, one or more QFIs, one or more QoS Profiles, N3 CN Tunnel Info, and/or an N1 SM container (PDU session establishment accept, among other. In some cases, the SMF 408 (e.g., a first network entity) may send, to the RAN 404 (e.g., a wireless communication node), PDU set related parameters in one or more QoS profiles. For example, if the SMF 408 determines that the current RAN 404 node supports PDU set QoS handling and the SMF 408 determines to establish QoS flows for the XR traffic, then QoS profiles including the PDU set related QoS parameters may be set. Otherwise, the QoS profiles may not include the PDU set related QoS parameters. The AMF 406 may forward N2 SM information to the RAN 404. The N1 SM container may include the PDU session establishment accept that the AMF 406 may provide to the UE 402. The UE 402 may use the traffic filters based on the traffic filters in the QoS rules to classify the UL XR traffic in the QoS flows.

The AMF 406 may send a message 430 to the RAN 404. The message 430 may include an N2 PDU session request comprising N2 SM information, a NAS message, a PDU Session ID, an N1 SM container, and/or a PDU session establishment accept. The AMF 406 may send, to the 5G-AN, the NAS message containing PDU session ID and PDU session establishment accept targeted to the UE 402 and the N2 SM information received from the SMF 408 within the N2 PDU session request.

The RAN 404 may communicate setup messages 432 with the UE 402. The RAN 404 may issue AN specific signaling exchange, with the UE 402, related with the information received from SMF 408. For example, in case of a 3GPP RAN, a radio resource control (RRC) connection reconfiguration may take place with the UE 402 establishing RAN resources related to the QoS rules for the PDU session request. The RAN 404 may forward the NAS message (e.g., including a PDU session ID, an N1 SM container, a PDU session establishment accept) to the UE 402. The RAN 404 may allocate AN N3 tunnel information for the PDU Session.

The RAN 404 may send a response 434 to the AMF 406. The response 434 may include an N2 PDU session response comprising a PDU session ID, a cause, and N2 SM information including a PDU session ID, AN tunnel info, and a list of accepted/rejected QFIs.

For example, if the RAN 404 receives the PDU set QoS parameter and the RAN 404 can support the PDU set handling, the RAN 404 may send an indication to the SMF 408 to indicate that the QoS PDU set handling for the QoS flows has been activated in the RAN 404 node. In some cases, the AN tunnel info may correspond to the Access Network (AN) address of the N3 tunnel corresponding to the PDU session. If the RAN 404 does not support the PDU set handling, the RAN 404 may continue the QoS flow handling without considering the PDU set QoS parameters.

The AMF 406 may send a request 436 to the SMF 408. The request 436 may include a Nsmf_PDUSession_UpdateSMContext request (e.g., N2 SM information). In some cases, the SMF 408 (e.g., a first network entity) may receive, from the RAN 404 (e.g., via the AMF 406), a message indicating that PDU set handling has been activated in the RAN 404 or the RAN 404 supports the PDU set handling. For example, the AMF 406 may forward the N2 SM information received from the RAN 404 to the SMF 408. If the list of rejected QFIs is included in the N2 SM information, the SMF 408 may release the QoS profiles associated with the rejected QFIs.

The SMF 408 may communicate messages 438 with the UPF 410. For example, the SMF 408 may initiate an N4 session modification procedure with the UPF 410. The SMF 408 may provide AN tunnel info to the UPF 410 (e.g., PSA/UPFO) and corresponding forwarding rules. In some cases, the SMF 408 (e.g., a first network entity) may send, to the UPF 410 (e.g., a third network entity) a message to activate PDU set handling in the UPF 410 for DL XR traffic. For example, if the SMF 408 receives indication from the RAN 404 node that the PDU set handling for the QoS flow has been activated in the RAN 404 node, the SMF 408 may provide information to the UPF 410 to activate the downlink XR traffic detection and classification. At 440, the RAN 404 and the UPF 410 may start PDU set handling.

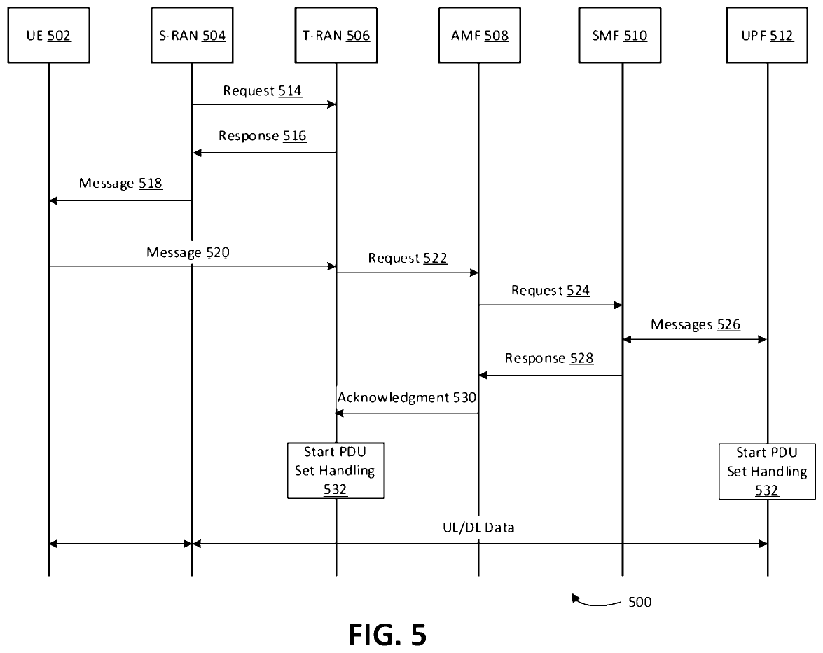

FIG. 5 is a diagram illustrating an example wireless communication 500 for determining network capability via control plane, according to various arrangements. The wireless communication 500 may include communications between a UE 502, a RAN 504 (e.g., an S-RAN), a RAN 506 (e.g., a T-RAN), an AMF 508, an SMF 510, and a UPF 512. The wireless communication 500 may depict examples of activating PDU set handling when the UE 502 moves to a target RAN node that supports PDU set handling. The SMF 510 may activate the PDU set handling in the UPF 512 via the control plane (e.g., signaling in the control plane). For example, the UPF 512 (e.g., a third network entity) of a core network may receive, from the SMF 510 (e.g., a first network entity) of the core network, PDU set related information.

At 514, the source RAN (S-RAN) node 504 may issue an Xn Handover Request message to the target RAN (T-RAN) node 506. The Xn Handover Request may include at least a target cell ID and PDU session related information. The PDU session related information may include slice information and QoS flow level QoS profiles, including the PDU Set related parameters of the QoS flow.

At 516, Admission Control may be performed by the target RAN node 506. The target RAN node 506 may prepare the handover with radio resources and may send a handover request acknowledge to the source RAN node 504. The handover request acknowledge may include a transparent container to be sent to the UE 502 as an RRC message to perform the handover.

At 518, the source RAN node 504 may trigger a Uu handover by sending an Xn handover Command message to the UE 502. The Xn handover Command message may include information to access the target cell.

At 520, the UE 502 may synchronize to the target cell and may complete the RRC handover procedure by sending a UE Access message to the target RAN node 506.

At 522, the target RAN node (e.g., NG-RAN) may send a request to the AMF 508. The request may include an N2 Path Switch Request comprising of a List of PDU Sessions To Be Switched with N2 SM Information, a List of PDU Sessions that failed to be established with the failure cause given in the N2 SM information element, and UE Location Information. If the T-RAN 506 receives the PDU Set QoS parameters from the S-RAN 504, and the T-RAN 506 can support the PDU Set handling, the T-RNA 506 may send an indication to the SMF 510 to indicate that the QoS PDU Set handling for the QoS flows has been activated in the T-RAN 506.

At 524, the AMF 508 may send a request to the SMF 510. The request may include a Nsmf_PDUSession_UpdateSMContext Request (e.g., N2 SM information received from the T-RAN 506). The AMF 508 may send N2 SM information by invoking the Nsmf PDUSession_UpdateSMContext request service operation for each PDU Session in the lists of PDU Sessions received in the N2 Path Switch Request. The Nsmf_PDUSession_UpdateSMContext Request may include either an indication that the PDU Session Is To Be Switched (together with information on the N3 addressing to use and on the transferred QoS flows) or an indication that the PDU Session is to be rejected (together with a rejection cause).

At 526, the SMF 510 may send an N4 Session Modification Request to the UPF 512 to update the AN Tunnel Info of the T-RAN 506. In some cases, the UPF 512 (e.g., a third network entity) may receive, from the SMF 510 (e.g., a first network entity), a message indicating that PDU set handling has been activated in the RAN 506 (e.g., a wireless communication node) or that the RAN 506 supports the PDU set handling. For example, if the SMF 510 receives indication from the RAN node 506 that the PDU Set handling for the QoS flow has been activated in the RAN node 506, the SMF 510 may provide information to the UPF 512 to activate the downlink XR traffic detection and classification.

At 528, the SMF 510 may send a response to the AMF 508. The response may include a Nsmf_PDUSession_UpdateSMContext Response (e.g., N2 SM information).

At 530, the AMF 508 may send an acknowledgment to the RAN 506. The acknowledgment may include an N2 Path Switch Request Ack (e.g., N2 SM Information).

At 532, the UPF 512 may activate PDU set handling for DL XR traffic. For example, the UPF 512 may start to detect (e.g., receive) the downlink XR traffic based on the PDR. The UPF 512 may add the PDU Set related information in a new GTP-U header and send the DL XR traffic together with the new GTP-U header (e.g., send information to the RAN node 506). The RAN node 506 may start to use the PDU Set information to optimize the XR traffic in the air interface. Otherwise, if the UPF 512 does not receive information that the PDU Set handling has been activated in the RAN 506, the UPF 512 may deactivate the PDU Set handling in the UPF 512.

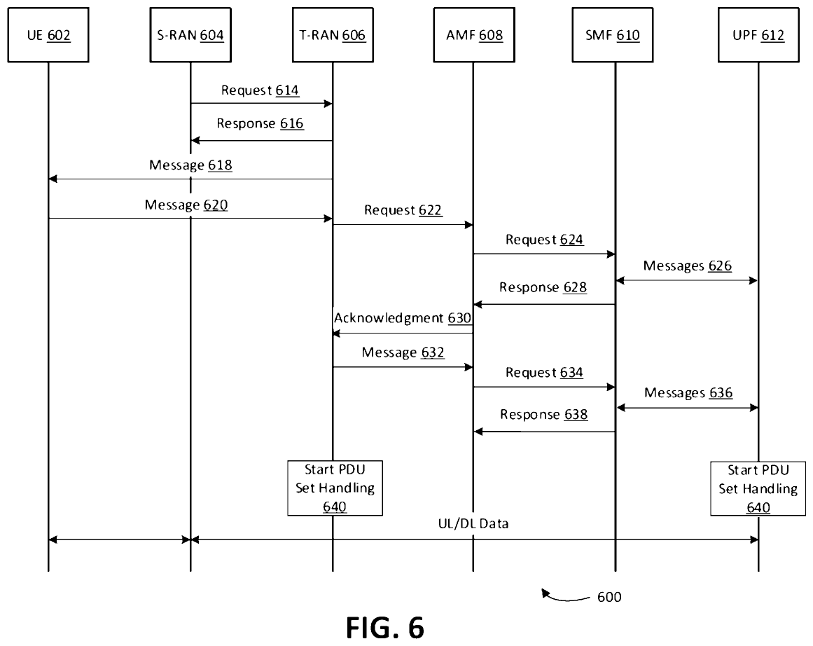

FIG. 6 is a diagram illustrating an example wireless communication 600 for determining network capability via control plane, according to various arrangements. The wireless communication 600 may include communications between a UE 602, a RAN 604 (e.g., an S-RAN), a RAN 606 (e.g., a T-RAN), an AMF 608, an SMF 610, and a UPF 612. The wireless communication 600 may depict examples of reactivating PDU set handling when the UE 602 moves to a new target RAN node that supports PDU set handling. The UPF 612 may deactivate the PDU set handling and determine to reactivate via the control plane (e.g., signaling in the control plane). For example, the RAN 606 (e.g., a wireless communication node) may receive, from the UPF 612 (e.g., a third network entity) of a core network, PDU set related information in one or more QoS profiles.

In some cases, the UPF 612 may deactivate PDU Set handling due to a RAN node in communication with the UPF 612 not supporting PDU Set handling (e.g., no PDU set handling parameters are stored in the current RAN node). The UE 602 may move to a new RAN node (e.g., the RAN node 606) that supports PDU Set handling.

At 614, the source RAN node 604 may issue a Xn Handover Request message to the target RAN node 606. The Xn Handover Request may include at least a target cell ID and PDU session related information. The PDU session related information may include slice information and QOS flow level QoS profiles, including PDU Set related parameters of the QoS flow.

At 616, Admission Control may be performed by the target RAN node 606. The RAN node 606 may prepare handover with radio resource and send a handover request acknowledge to the source RAN 604. The handover request acknowledge may include a transparent container to be sent to the UE 602 as an RRC message to perform the handover.

At 618, the source RAN node 604 may trigger a Uu handover by sending an Xn handover Command message to the UE 602. The Xn handover Command message including information to access the target cell.

At 620, the UE 602 may synchronize to the target cell and complete the RRC handover procedure by sending a UE Access message to the target RAN node 606.

At 622, the target RAN 606 (e.g., an NG-RAN) may send a request to the AMF 608. The request may include an N2 Path Switch Request comprising a List of PDU Sessions To Be Switched with N2 SM Information, a List of PDU Sessions that failed to be established with the failure cause given in the N2 SM information element, and UE Location Information.

At 624, the AMF 608 may send a request to the SMF 610. The request may include a Nsmf_PDUSession_UpdateSMContext Request (e.g., N2 SM information received from T-RAN). The AMF 608 may send N2 SM information by invoking the Nsmf_PDUSession_UpdateSMContext request service operation for each PDU Session in the lists of PDU Sessions received in the N2 Path Switch Request. The Nsmf_PDUSession_UpdateSMContext Request may include either an indication that the PDU Session Is To Be Switched (together with information on the N3 addressing to use and on the transferred QoS flows) or an indication that the PDU Session is to be rejected (together with a rejection cause).

At 626, the SMF 610 may send an N4 Session Modification Request to the UPF 612 to update the AN Tunnel Info of the T-RAN 606.

At 628, the SMF 610 may send a response to the AMF 608. The response may include a Nsmf_PDUSession_UpdateSMContext Response (e.g., N2 SM information). The SMF 610 may set the QoS Profiles in the N2 SM information that includes the PDU Set related QoS parameters.

At 630, the AMF 608 may send an acknowledgment to the RAN 606. The acknowledgment may include an N2 Path Switch Request Ack (e.g., N2 SM Information,).

At 632, if the T-RAN node 606 receives the PDU Set related QoS parameters from the SMF 610 at 628, and if the T-RAN 606 supports the PDU Set handling, the RAN 606 may send a PDU Session Resource Notification to the AMF 608. The PDU Session Resource Notification may include an indication that the PDU Set handling is supported in the RAN node 606, or the PDU Set handling has been activated in the T-RAN 606.

At 634, the AMF 608 may send a request to the SMF 610. The request may include a Nsmf_PDUSession_UpdateSMContext Request. The Nsmf_PDUSession_UpdateSMContext Request may include either an indication that the PDU Set handling is supported in the RAN node 606, or the PDU Set handling has been activated in the T-RAN 606.

At 636, the SMF 610 may send an N4 Session Modification Request to the UPF 612. If the SMF 610 receives the indication from the RAN node 606 that the PDU Set handling for the QoS flow has been activated in the RAN node 606, the SMF 610 may provide information to UPF 612 to activate the downlink XR traffic detection and classification.

At 638, the SMF 610 may send a response to the AMF 608. The response may include a Nsmf_PDUSession_UpdateSMContext Response.

At 640, responsive to the UPF 612 receiving the indication that the RAN 606 supports the PDU Set handling or the PDU Set handling has been activated in the T-RAN 606, the UPF 612 may start to detect the downlink XR traffic based on the PDR. The UPF 612 may add the PDU Set information in the GTP-U header and send them to the RAN node 606. The RAN node 606 may start to use the PDU Set information to optimize the XR traffic in the air interface.

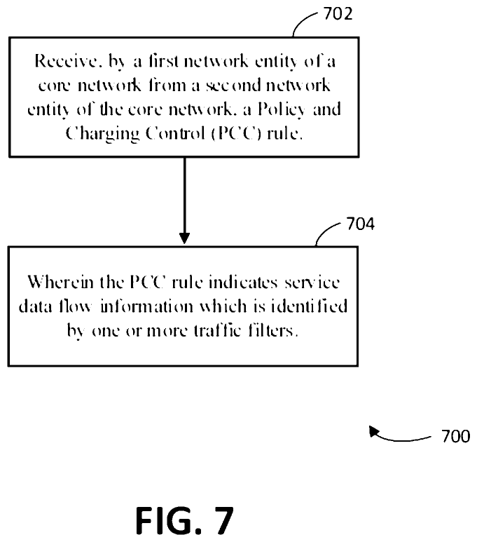

FIG. 7 is a flowchart diagram illustrating an example method 700 for determining network capability via control plane, according to various arrangements. In some cases, the method 700 may include configurations for a network entity to receive a PCC rule indicating service data flow information identified by one or more traffic filters.

At 702, a first network entity of a core network may receive, form a second network entity of the core network, a PCC rule. At 704, the PCC rule may indicate service data flow information which is identified by one or more traffic filters. In some cases, the first network entity may send PDU set related parameters (e.g., in one or more QoS profiles) to detect DL traffic. The first network entity may receive a message indicating that PDU set handling has been activated in a wireless communication node. The first network entity may send a message to activate PDU set handling for XR traffic.

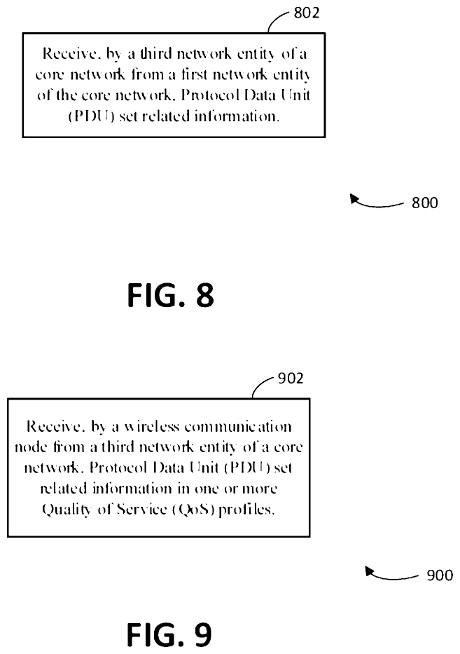

FIG. 8 is a flowchart diagram illustrating an example method 800 for determining network capability via control plane, according to various arrangements. In some cases, the method 800 may include configurations for a network entity to receive PDU set related information.

At 802, a third network entity of a core network may receive, from a first network entity of the core network, PDU set related information. In some cases, the third network entity may receive a message indicating that PDU set handling has been activated or that PDU set handling is supported. The third network entity may activate PDU set handling for DL XR traffic and receive the DL XR traffic. The third network entity may add PDU set related information in a new GTP-U header and send the DL XR together with the new GTP-U header.

FIG. 9 is a flowchart diagram illustrating an example method 900 for determining network capability via control plane, according to various arrangements. In some cases, the method 900 may include configurations for a wireless communication node to receive PDU set related information.

At 902, a wireless communication node may receive, from a third network entity of a core network, PDU set related information in one or more QoS profiles. In some cases, the wireless communication node may send a message indicating that PDU set handling has been activated in the wireless communication node or the wireless communication node supports the PDU set handling.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
receiving, by a first network entity of a core network from a second network entity of the core network, a Policy and Charging Control (PCC) rule;
wherein the PCC rule indicates service data flow information which is identified by one or more traffic filters.

2. The wireless communication method of claim 1, further comprising sending, by the first network entity to a wireless communication node, Protocol Data Unit (PDU) set related parameters in one or more Quality of Service (QOS) profiles.

3. The wireless communication method of claim 1, further comprising sending, by the first network entity to a third network entity of the core network, Protocol Data Unit (PDU) set related parameters to detect downlink traffic.

4. The wireless communication method of claim 1, further comprising receiving, by the first network entity from a wireless communication node, a message indicating that Protocol Data Unit (PDU) set handling has been activated in the wireless communication node or the wireless communication node supports the PDU set handling.

5. The wireless communication method of claim 1, further comprising sending, by the first network entity to a third network entity of the core network, a message to activate Protocol Data Unit (PDU) set handling in the third network entity for downlink extended Reality (XR) traffic.

6. A wireless communication method, comprising:
receiving, by a third network entity of a core network from a first network entity of the core network, Protocol Data Unit (PDU) set related information.

7. The wireless communication method of claim 6, further comprising receiving, by the third network entity from the first network entity, a message indicating that PDU set handling has been activated in a wireless communication node or the wireless communication node supports the PDU set handling.

8. The wireless communication method of claim 6, further comprising activating, by the third network entity, PDU set handling for downlink extended Reality (XR) traffic.

9. The wireless communication method of claim 8, further comprising receiving, by the third network entity, the downlink XR traffic.

10. The wireless communication method of claim 9, further comprising adding, by the third network entity, the PDU set related information in a new General Packet Radio Service (GPRS) Tunneling Protocol-User plane (GTP-U) header.

11. The wireless communication method of claim 10, further comprising sending, by the third network entity to a wireless communication node, the downlink XR traffic together with the new GTP-U header.

12. A wireless communication method, comprising:
receiving, by a wireless communication node from a third network entity of a core network, Protocol Data Unit (PDU) set related information in one or more Quality of Service (QOS) profiles.

13. The wireless communication method of claim 12, further comprising sending, by the wireless communication node to the third network entity, a message indicating that PDU set handling has been activated in the wireless communication node or the wireless communication node supports the PDU set handling.

14. The wireless communication method of claim 1, wherein the one or more traffic filters are configured to indicate how to detect extended Reality (XR) traffic.

15. The wireless communication method of claim 1, wherein the one or more traffic filters are configured to indicate at least one of IP 5 tuple information of XR traffic, Real-time Transport Protocol (RTP) header information, RTP pay-load information, RTP Control Protocol (RTCP) header information, secure RTP (SRTP) header information, SRTP pay-load information, or secure RTCP (SRTCP) information.

16. The wireless communication method of claim 2, wherein the PDU set related parameters are configured for extended Reality (XR) or media service.

17. The wireless communication method of claim 2, wherein the PDU set related parameters comprises at least one of PDU Set Delay Budget (PSDB), PDU Set Error Rate (PSER) or PDU Set Integrated Handling Information (PSIHI).

18. An apparatus for wireless communication, comprising a processor, wherein the processor is configured to implement a method recited in claim 1.

19. An apparatus for wireless communication, comprising a processor, wherein the processor is configured to implement a method recited in claim 6.

20. An apparatus for wireless communication, comprising a processor, wherein the processor is configured to implement a method recited in claim 12.
